(19) United States
(12) Patent Application Publication
(10) Pub. No.: US 2014/0379539 A1
(43) Pub. Date: Dec. 25, 2014

(54) SYSTEMS AND METHODS FOR GENERATING BILLING DATA OF A COMPOSITE CLOUD SERVICE

(71) Applicant: Infosys Limited, Bangalore (IN)

(72) Inventors: Shyam Kumar Doddavula, Bangalore (IN); Arun Viswanathan, Bangalore (IN); Mudit Kaushik, Meerut (IN); Raghavan Subramanian, Bangalore (IN)

(73) Assignee: INFOSYS LIMITED, Bangalore (IN)

(21) Appl. No.: 14/219,895

(22) Filed: Mar. 19, 2014

(30) Foreign Application Priority Data
Jun. 24, 2013 (IN) 2718/CHE/2013

(51) Int. Cl. G06Q 20/14

(52) U.S. Cl. CPC G06Q 20/145
USPC 705/34

(57) ABSTRACT

The technique relates to a system and method for generating billing data of a composite cloud service. The technique tracks and meters manual service usage along with the infrastructure and software usage to generate billing data for the composite cloud service. The technique involves receiving a user request for the composite cloud service. After receiving the user request, one or more infrastructure, software and manual resources required to fulfill the user request are provisioned. Thereafter, the consumption of the one or more infrastructure, software and manual resources in real time to fulfill the user request is measured based on a predefined monitoring metrics. Finally, billing data for the composite cloud service is generated based on the measured consumption data of the one or more infrastructure, software and manual resources, a predefined chargeback model and a predefined billing policy.

### FIELD

The field relates generally to generate billing data of a cloud service, and in particular, to a system and method for generating billing data of a composite cloud service, wherein the composite cloud service includes infrastructure as a service, software as a service and manual services.

### BACKGROUND

Cloud computing delivers information technology service such as infrastructure, software etc. as a utility over the network. It allows end users to obtain access to computation, software, data, storage and network without requiring user knowledge with regards to the actual location or configuration of the underlying service. There are several public cloud providers offering cloud services like Infrastructure as a Service (or IaaS), Platform as a Service (or PaaS) and Software as a Service (SaaS). Each of these services provides a flexible way for the user to provision any of these services that are required on demand, and the user can pay only for those services that are used. There are several challenges associated with adopting public cloud services like security risks because of shared infrastructure with other tenants, regulatory compliance challenges etc. So, several large enterprises are creating enterprise private clouds that create a common pool of infrastructure and leverage that for offering cloud services to their different organization units.

A key challenge for cloud providers including public, private and hybrid clouds is to develop a solution for metering the various cost elements involved in delivering a composite cloud service that have been used and charge the users based on that. There are several products available in the market to monitor the resource usage, but they are designed only for tracking infrastructure usage. These products have the have the limitation that they do not take the people factor into consideration to address the costs involved in utilizing skilled people to provide services along with software and infrastructure as a combined composite service as part of the metering and billing method.

### SUMMARY

The present technique overcomes the above mentioned limitation by addressing the complexities of metering and billing a composition of infrastructure, software and manual effort as a single unit. The invention helps in allowing enterprise cloud providers to define and implement a chargeback and billing solution for composite cloud services that include infrastructure, software and manual services. It also describes the metrics for the various components and how to define a billing policy. Based on the metered data for the provisioned services and the associated billing policy, the user can be charged. This enables better alignment of the cloud service consumption to the associated business benefits when applied in the context of an enterprise private cloud.

According to one embodiment of the present disclosure, a method for generating billing data of a composite cloud service is disclosed. The method includes receiving a user request for the composite cloud service. After receiving the user request, one or more infrastructure, software and manual resources required to fulfill the user request are provisioned. Thereafter, the consumption of the one or more infrastructure, software and manual resources in real time to fulfill the user request is measured based on a predefined monitoring metrics. Finally, billing data for the composite cloud service is generated based on the measured consumption data of the one or more infrastructure, software and manual resources, a predefined chargeback model and a predefined billing policy.

In an additional embodiment, a system for generating billing data of a composite cloud service is disclosed. The system includes a user request receiving module, a provisioning module, a metering module and a billing module. The user request receiving module is configured to receive a user request for the composite cloud service. The provisioning module is configured to provision one or more infrastructure, software and manual resources required to fulfill the user request. The metering module is configured to measure consumption of the one or more infrastructure, software and manual resources in real time to fulfill the user request based on a predefined monitoring metrics. The billing module is configured to generate billing data for the composite cloud service based on the measured consumption data of the one or more infrastructure, software and manual resources, a predefined chargeback model and a predefined billing policy.

In another embodiment, a computer-readable storage medium for generating billing data of a composite cloud service is disclosed. The computer-readable storage medium which is not a signal stores computer-executable instructions for receiving a user request for the composite cloud service, provisioning one or more infrastructure, software and manual resources required to fulfill the user request, measuring consumption of the one or more infrastructure, software and manual resources in real time to fulfill the user request based on a predefined monitoring metrics and generating billing data for the composite cloud service based on the measured consumption data of the one or more infrastructure, software and manual resources, a predefined chargeback model and a predefined billing policy.

### DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein;

FIG. 2 is a flowchart, illustrating a method for generating billing data of a composite cloud service, in accordance with an embodiment of the present invention; and

FIG. 3 is a block diagram illustrating a system for generating billing data of a composite cloud service, in accordance with an embodiment of the present invention.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present technique provide a system and method for generating billing data of a composite cloud service. This involves receiving a user request for composite cloud service and based on the user request one or more infrastructure, software and manual resources are provisioned. The real time consumption of the one or more infrastructure, software and manual services is measured based on a predefined monitoring metrics and finally, billing data of the composite cloud service is generated based on the measured consumption data of the one or more infrastructure, software and manual resources, a predefined chargeback model and a predefined billing policy.

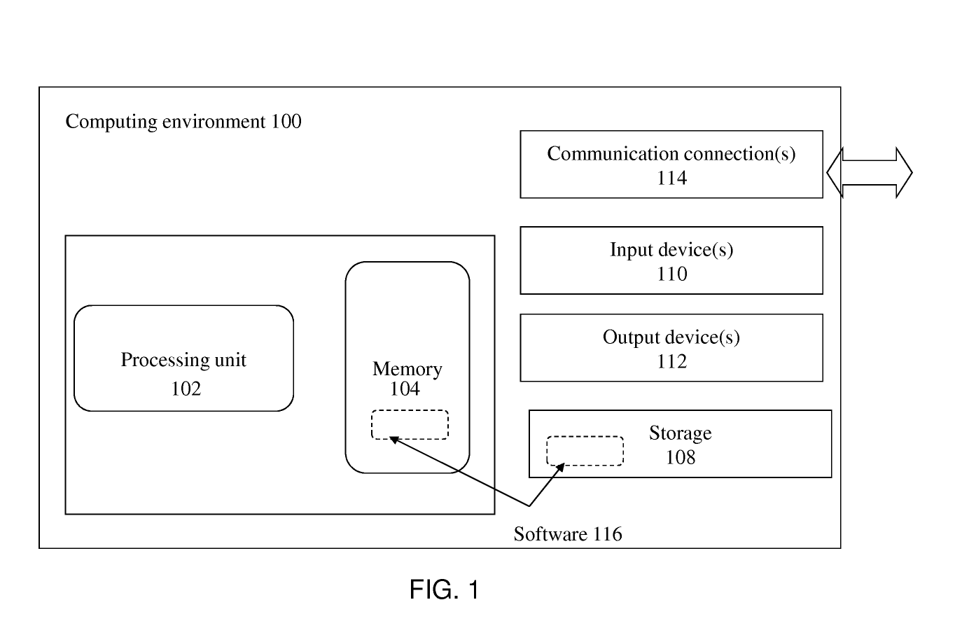

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

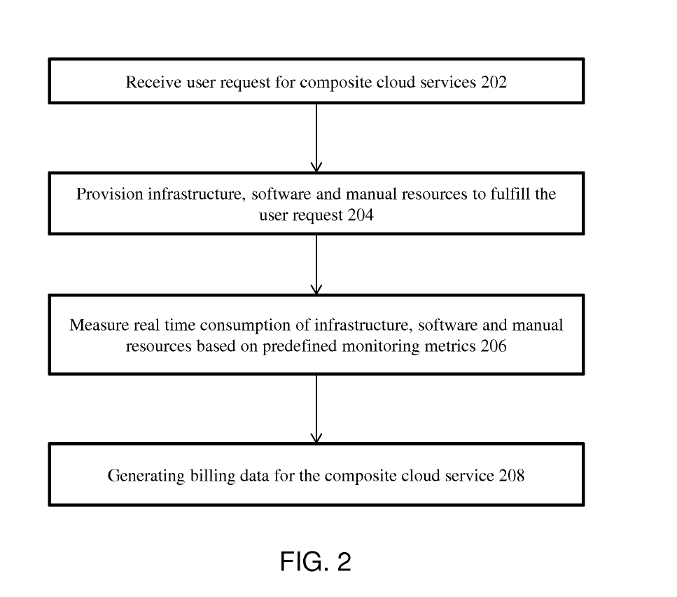

FIG. 2 is a flowchart, illustrating a method for generating billing data of a composite cloud service, in accordance with an embodiment of the present invention. A user request is received for a composite cloud service, as in step 202. The user may log into a self-service portal and chose a service type from the Service Catalog provided through the portal. For the service type chosen, the required infrastructure resources can be defined for each tier of the service. In a multi-provider setup, the user can further choose a cloud provider where the service needs to be provisioned or the selection of cloud provider can be automated driven by policies. Then the one or more infrastructure, software and manual resources required to fulfill the user request are provisioned, as in step 204. To provision the one or more resources the following details are collected from the user at the time of receiving the user request:
a) Number of Units of work—This attribute is used to quantify the work in a value that can be measured and charged.
b) Type of Service—This attribute is used to identify the service that is required for the user. For example, the user could request Testing Services for a Java web based application or a .NET web application or a data warehouse application and so on.
c) Duration of service—This attribute is used to capture the duration for which the above mentioned service is required.

Based on the combination of above provided attributes, the system can internally identify the infrastructure needed, the software licenses needed, the number of people required for providing the manual services and the skill level of the people involved. The real time consumption of the one or more infrastructure, software and manual resources are measured based on a predefined monitoring metrics, as in step 206. The monitoring metrics capture the metric name, the unit of measurement and the type of resource as follows:

TABLE 1

| Metric Name | Metric Unit | Resource Type |
|---|---|---|
| Servers Used | Number | VM |
| Licenses Used | Number | Software |
| Work Done | Function Points | Manual Services |

Table 1 shows a sample metrics that can be monitored across the different types of resources. In the infrastructure that has been provisioned, the usage of the number of virtual machines can be tracked. Similarly for software provisioned, its metrics for monitoring can be the number of licenses of that software used or the amount of time the software was in running state. For services such as “Test-as-a-Service” where skilled testers can be provided along with the required hardware and software resources, their efforts can be tracked based on various factors which include dynamic allocation and de-allocations of people providing the professional services, skill and experience based costs, costs based on onsite and offshore models, different types of contracts like fixed price professional services contracts based on parameters like deliverables, quality etc, time and contracts based on the duration and number of people, travel costs, communication costs, costs unique to people aspects like overtime costs that are negotiated or mandated by local labor laws and so on. The unit cost and the service instances for the one or more resources are calculated to determine the consumption level. The exemplary metering data may be as follows:

TABLE 2

| Infrastructure | Software | Manual Service | All |
|---|---|---|---|
| Number of | Number of | Units of Work - 5 | Duration - 2 weeks |
| Resources - 3 | Licenses: | FP | Location - US |
| | RHEL - 3 | Duration - 2 weeks | Number of Bugs = 0 |
| | Apache - 1 | Type of Work - | |
| | WebLoad - 1 | Testing | |
| | WebSphere - | Location - US | |
| | 2 | Number of Bugs = 0 | |

Referring back to FIG. 2, billing data for the composite cloud service is generated based on the measured consumption data of the one or more infrastructure, software and manual resources, a predefined chargeback model and a predefined billing policy, as in step 208. The chargeback model can be any of the following:
i) Fixed Price for a service type for a duration irrespective of amount of usage
   A user could be charged a standard price for a particular type of service that is based on the duration the service is required to be used. The service provisioned in this model could be used however as required by the user.
ii) A fixed rate is determined for a service type for a pre-defined unit of service usage for a defined time unit with pre-defined SLAs and the user can order as many multiple of the units of the service instance as needed for whatever multiples of the time units
   In this model, different types of “Composite Service Units” (CSU) can be pre-defined with standard SLAs, metrics and a fixed rate for each unit. The different types of CSU could be Mini CSU, Mid CSU, Max CSU, etc. The user could then request for a CSU for a particular duration and charged based on its base rate for that period only. Another variation of this model could be in terms of the duration—With a fixed start date or fixed end date or both
iii) Variable rate for a service unit which is determined at the time of actual usage based on factors like current demand, availability of service units etc.
iv) Negotiated rate for a service unit that is based on auction mechanisms
   This model works on the dynamics of the demand and supply of the resources on the multi-cloud multi-tenant setup. The user places the bids for the desirable service (indirectly placing the bid for the resources required to execute that service) on the auction portal of the system. This model simply allocates the resources when the availability as well as the cost of the service rendered matches to the bid of the user. This model is designed to cater the need of cost sensitive users. The cost factor of the service will depend on the different parameters of the SLA like billing policy, resource criticality, time period, etc.
   The charge back models described above could require the following parameters:

TABLE 3

| Chargeback Parameters | Sample Values |
|---|---|
| Infrastructure Resource Type (R-I) | VM, CPU, Memory, Bandwidth |
| Software Resource Type (R-S) | Licenses, License Pack, |
| | Subscription |
| Manual Resource Type (R-M) | Testing Service Unit |
| Infrastructure Metrics (M-I) | Servers Used, CPU Usage, Memory |
| | Usage |
| Software Metrics (M-S) | Licenses Used, Subscription Model |
| Manual Metrics (M-S) | Number of Work Units, Effort, |
| | Duration |
| Rate Factor (F) | 1 |
| Units (U) | Number |
| Duration (T) | Hourly, Daily, Monthly |
| Base Cost (BC) | $X |
| Overcharge Cost (OC) | $Y |
| Fixed Cost (FC) | $Z |
| Overtime Costs (OV) | $X2 |
| Location (L) | Offshore, Onshore, Near Shore |
| Currency | USD |

The Billing policy will be deduced as follows:

Billing Policy=Function(R+M+F+U+T+OC+FC)

This translates into mathematical equation for calculating the total charge:

The Consumption for each Resource Type (C_{R}) is determined by the duration for which a virtual machine server is running.

C_{R}=U×T

Based on the consumption or usage determined, the Charge for each Resource Type (CH_{R}) is determined based on the base cost for that unit and the rate factor. This translates as follows:

CH_{R}=(BC×F×C_{R})

There will be a fixed cost (FC) involved for each resource type which will then be added to the Total Charge for each Resource (TCH_{R}). Further in case a resource is used more than the duration that it was requested for, an Overcharge Cost (OC) will be applied for the additional duration.

This is represented as follows:

TCH_{R}=FC+CH_{R}+(OC×T)

The Total Cost for the Service Type (TCs) will then be the sum of the Total Charge for infrastructure, software and manual service resources that are provisioned as part of the Service Type.

The cost of manual services include dynamic allocation and de-allocations of people providing the professional services, skill and experience based costs, costs based on onsite and offshore models, different types of contracts like fixed price professional services contracts based on parameters like deliverables, quality etc, time and contracts based on the duration and number of people, travel costs, communication costs, costs unique to people aspects like overtime costs that are negotiated or mandated by local labor laws and so on.

Dynamic People Allocation and De-Allocation Cost Model:

Unlike in a traditional services delivery models, in a cloud based delivery model the services are subscription based so there can be dynamic changes in the requirements so, the number of people allocated to deliver a cloud service instance can vary over time. It can even be driven by an automated resource allocation algorithm using statistical regression & forecasting techniques and predictive machine learning algorithms predicting and optimizing the allocations. The chargeback system includes a component that is integrated with the resource allocation component to enable track the allocations and de-allocations.

Skill and Experienced Based Cost Model:

The composite cloud service definition includes quantification of the complexity of the tasks and the skill and experience level combinations needed. Taxonomy of ‘skill’ and experience with different level of the subject matter expertise (SME) and experience is created and unit cost for each level is calculated for different sourcing models:

TABLE 4

| | | Intermediate | |
|---|---|---|---|
| Skill/NOY | Basic skills | skills | Expert skills |
| 1 year | 10 units | 20 untis | 40 units |
| 2 years | 20 units | 40 untis | 80 untis |
| 3 years | . . . | . . . | . . . |

Onsite/Offshore Cost Models:

A Global Delivery Model (GDM) with optimal Onsite/Offshore location of people delivering the professional services is created based on the business needs, time zone issues, economic factors and so on. The chargeback system includes a components that track the onsite and offshore allocations which can keep changing. It also uses historical data and tracks the various expenses associated with these for the various sourcing models to arrive at unit costs.

Fixed Price, Time & Material Contract Cost Model:

In a fixed price contract the professional services are procured based on pre-defined service unit definitions. In another model the rates agreed upon for the skill and experience levels for the various locations and subject matters and based and based on the number of people, the duration of their allocation and their billing rates the costs are arrived at. The charge back system includes a component that enables track these contracts for the various contractors to enable arrive at the costs.

Overhead Costs—Travel, Communication & Over Time Cost (TCO):

Delivering the professional services includes several overhead costs like travel and communication costs, costs for over time etc which are also tracked by a component in the charge back system.

In House Employees Performing Services (IH-S):

The costs for this model are arrived at tracking and using the Dynamic people allocation and de-allocations, skills & experience based costs, onsite & offshore mix. The salary costs and overhead costs are used to arrive at the overall costs and then the unit costs:

It is a function of [Dynamic people allocation and de-allocation (DPA)], [Skill and experienced based cost (SE)], [Onsite/Offshore models cost (OO)], [Contractor Cost (CC, [Overhead costs, Travel, Communication & Over time cost (OHC)] each of which is a function of time

∫(DPA(t),SE(t),OO(t),CC(t),OHC(t)) t=0 to t

Contractors Performing Services (C-S):

The costs for this model are arrived at by tracking the various contracts and the dynamic people allocation and de-allocations belonging to the various contracts, skills & experience based costs defined in the contracts and the overhead costs.

Outsourced Provider Providing Services (OP-S):

The costs for this model are arrived by at by tracking the Fixed Price (FP) and Time & Material (T & M) contracts. For the T & M contracts, costs are arrived by at, by tracking the allocation and de-allocations of people and their corresponding skills & experience, the skills & experience based costs defined in the contracts, the overhead costs etc. For the FP contracts, the units of work allocated, the milestones delivered are tracked and the costs are arrived at.

Crowd-Sourced People Service (CS-S):

Crowd sourcing is a type of participative online activity in which an individual, an institution, a non-profit organization, or company proposes to a group of individuals of varying knowledge, heterogeneity, and number, via a flexible open call, the voluntary undertaking of a task. The work units are split and crowd sourcing is employed to get them completed. The costs for the overheads and any payments agreed upon are used to arrive at the costs of this model.

Auctioned Model for Services (AM-S):

In the auctioned model, the work unit is auctioned through various auction models. The costs of this model are arrived at based on the pricing arrived at through the auction and by tracking the work allocations.

All these different types of manual services are summed up to calculate the total manual service cost as mentioned below:

a(IH-S)+b(C-S)+c(OP-S)+d(CS-S)+e(AM-S)

The total charge of the manual services would be

TCH_{R} (Manual Services)=Function(R-M, M-S, F, U, T, BC, OV, L)

Thus, the total charge of the composite cloud service would be:

TCs=TCH_{R}(Infrastructure)+TCH_{R}(Software)+TCH_{R}(Manual Services)

In accordance with an embodiment of the present technique, future requirement of the one or more infrastructure, software and manual resources for fulfilling the user request is predicted based on historical data and a forecaster. In this step, at predetermined intervals, the resource allocation and the chargeback rates are computed. It involves the following stages:

a) Forecast Future Resource Usage
Historical data is maintained for infrastructure, software and manual service usage as well as for the workloads for each individual service instance. Using this data and applying a forecaster based on techniques like linear regression, future workload and infrastructure usage is predicted and accordingly the CPU, memory, RAM, etc. can be reserved and allocated for the specific services.

b) Re-Allocate Resources and Update Chargeback Rates
Based on the inputs from Monitoring and Forecasting components, resources requirements for each service instance is re-calculated. Then reallocation process is kicked off which is the different for different resource allocations models as described below:
   Fixed Rate for a Service Unit with a fixed end date—Resources are allocated for service instances of this category first.
   Negotiated Rate for a Service Unit—For this model of chargeback, users could bid to the service units available at a particular point of time. Based on the demand of the service unit, the prices are decided and applied to the resources within the service unit. These services are picked up first for processing. After applying the bid process the chargeback rates are determined and the also resources for this category of composite cloud services is determined.
   Variable Rate for a Service Unit—For this model, the rate will vary based on the time of actual usage determined by factors such as current demand, availability of service units, number of units requested, etc. For e.g. consider a service “SAP Testing Service” which is in high demand, then the rate for this service would be higher than a service say, “Web Testing Service”. For service instances in this, a probabilistic model is used to arrive at expected percentage of utilization of resources and using that factor the rates are determined. For example if the utilization is expected to go beyond 100 percent, the rates are increased and if not the rates are reduced.
   Fixed Rate for a Service Unit with a variable end date—Resources are allocated for service instances of this category towards the end after all other service instances have been assigned resources based on what are available.

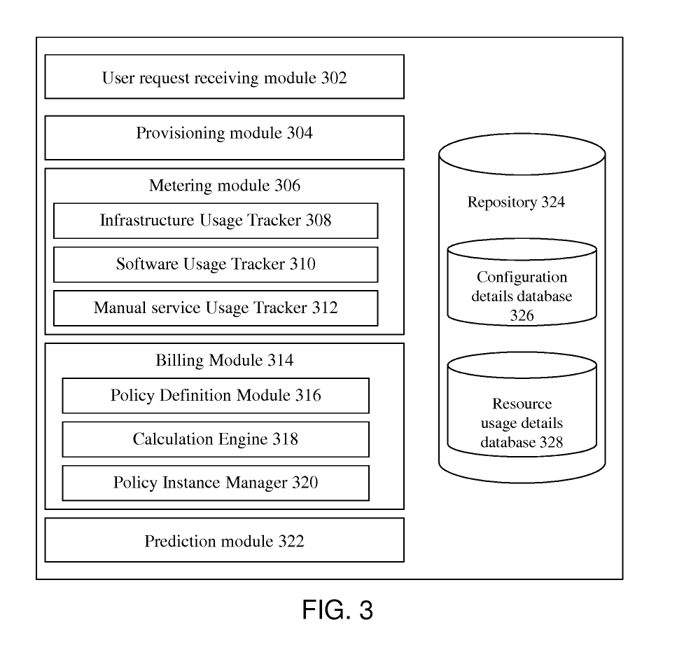

FIG. 3 is a block diagram illustrating a system for generating billing data of a composite cloud service, in accordance with an embodiment of the present invention. More particularly, the system includes a user request receiving module 302, a provisioning module 304, a metering module 306 and a billing module 314. The user request receiving module 302 is configured to receive a user request for the composite cloud service. The provisioning module 304 is configured to provision one or more infrastructure, software and manual resources required to fulfill the user request. The metering module 306 is configured to measure consumption of the one or more infrastructure, software and manual resources in real time to fulfill the user request based on a predefined monitoring metrics. The monitoring metrics are described in detail herein above. The metering module 306 further comprises an infrastructure usage tracker 308, a software usage tracker 310 and a manual service usage tracker 312. The infrastructure usage tracker 308 is configured to track and meter the uses of infrastructure resources such as servers, networks, storage and so on. It will track the utilization of resources in terms of number of units used. The software usage tracker 310 is configured to track and meter the usage of software such as operating system, products, databases and so on. It will also track the software licenses used, support subscription taken and the costs related to software patches and upgrades. The manual service usage tracker 312 is configured to track and meter the manual services as described in detail herein above. The billing module 314 is configured to generate billing data for the composite cloud service based on the measured consumption data of the one or more infrastructure, software and manual resources, a predefined chargeback model and a predefined billing policy. The chargeback model and the billing policy are described in detail herein above. The billing module further comprises a policy definition module 316, a calculation engine 318 and a policy instance manager 320. The policy definition module 316 is configured to define the billing policies across different resource types. The calculation engine 318 is configured to calculate the pricing for an individual user based on the usage metrics collected and resources utilized. This price for a user can include fixed costs as well as variable costs. The policy instance manager 320 is configured to manage the billing policy for a service instance. In accordance with an embodiment of the present technique a prediction module 322 is configured to predict future requirement of the one or more infrastructure, software and manual resources for fulfilling the user request based on historical data and a forecaster. The details of predicting future requirements and reallocation based on the prediction are described in detail herein above. The system further includes a repository 324 which comprises of configuration details database 326 and resource usage details database 328.

One or more computer-readable media (e.g., storage media) or one or more processor-readable media (e.g., storage media) can comprise computer-executable instructions causing a computing system (e.g., comprising one or more processors coupled to memory) (e.g., computing environment 100 or the like) to perform any of the methods described herein. Examples of such computer-readable or processor-readable media include magnetic media, optical media, and memory (e.g., volatile or non-volatile memory, including solid state drives or the like).

The above-mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer-implemented method for generating billing data of a composite cloud service, the method comprising:
receiving a user request for the composite cloud service;
provisioning one or more infrastructure, one or more software, and one or more manual resources required to fulfill the user request;
measuring consumption of the one or more infrastructure, one or more software and one or more manual resources in real time to fulfill the user request based on a predefined monitoring metrics; and
generating billing data for the composite cloud service based on the measured consumption data of the one or more infrastructure, one or more software and one or more manual resources, a predefined chargeback model and a predefined billing policy.

2. The method as claimed in claim 1 further comprising:
predicting future requirements of the one or more infrastructure, software and manual resources for fulfilling the user request based on historical data and a forecaster;
re-allocating the one or more infrastructure, one or more software and one or more manual resources based on the prediction; and
updating chargeback rates based on the re-allocation.

3. The method as claimed in claim 1, wherein provisioning comprises determining one or more manual service types, one or more infrastructure types and one or more software types required to fulfill the user request.

4. The method as claimed in claim 1, wherein provisioning the one or more manual resources includes quantifying one or more manual service units based on one or more function points, types of services and duration of services.

5. The method as claimed in claim 1, wherein provisioning the one or more manual resources involves use of one or more mechanisms of sourcing the manual resources.

6. The method as claimed in claim 5, wherein the one or more mechanisms of sourcing the manual resources include in-house employees performing services, contractors performing services, outsource providers providing services, crowd-sourced people services and auctioned services.

7. The method as claimed in claim 1, wherein the step of measuring comprises determining one or more service instances and one or more service units of the one or more infrastructure, one or more software and one or more manual resources consumed to fulfill the user request.

8. The method as claimed in claim 7, wherein the billing data is generated by calculating price of the one or more service units consumed to fulfill the user request.

9. The method as claimed in claim 1, wherein the billing is fixed or variable or negotiated or determined through auction.

10. The method as claimed in claim 1, wherein the measured consumption data of the one or more manual resources comprise one or more factors.

11. The method as claimed in claim 10, wherein the one or more factors include skill level, duration of service, amount of work performed, location, effort spent, overtime effort spent and service level agreement.

12. A system for generating billing data of a composite cloud service, comprising:
a processor in operable communication with a processor-readable storage medium, the processor-readable storage medium containing one or more programming instructions whereby the processor is configured to implement:
a user request receiving module configured to receive a user request for the composite cloud service;
a provisioning module configured to provision one or more infrastructure, software and manual resources required to fulfill the user request;
a metering module configured to measure consumption of the one or more infrastructure, software and manual resources in real time to fulfill the user request based on a predefined monitoring metrics; and
a billing module configured to generate billing data for the composite cloud service based on the measured consumption data of the one or more infrastructure, software and manual resources, a predefined chargeback model and a predefined billing policy.

13. The system as claimed in claim 12 further comprising a prediction module configured to predict future requirement of the one or more infrastructure, software and manual resources for fulfilling the user request based on historical data and a forecaster.

14. The system as claimed in claim 12, wherein the provisioning module determines one or more manual service types, one or more infrastructure types and one or more software types required to fulfill the user request.

15. The system as claimed in claim 12, wherein the metering module comprises an infrastructure usage tracker, a software usage tracker and a manual service usage tracker.

16. The system as claimed in claim 12, wherein the metering module determines one or more service instances and one or more service units of the one or more infrastructure, software and manual resources consumed to fulfill the user request.

17. The system as claimed in claim 12, wherein the billing module comprises a policy definition module, a calculation engine and a policy instance manager.

18. The system as claimed in claim 17, wherein the calculation engine calculates the price of the one or more service units consumed to fulfill the user request which is required to generate the billing data.

19. The system as claimed in claim 12, wherein the measured consumption data of the one or more manual resources comprise one or more factors.

20. The system as claimed in claim 19, wherein the one or more factors include skill level, duration of service, amount of work performed, location, effort spent, overtime effort spent and service level agreement.

21. A computer-readable storage medium, that is not a signal, having computer-executable instructions stored thereon for generating billing data of a composite cloud service, the said instructions comprising:
instructions for receiving a user request for the composite cloud service;
instructions for provisioning one or more infrastructure, one or more software and one or more manual resources required to fulfill the user request;
instructions for measuring consumption of the one or more infrastructure, one or more software and one or more manual resources in real time to fulfill the user request based on a predefined monitoring metrics; and
instructions for generating billing data for the composite cloud service based on the measured consumption data of the one or more infrastructure, one or more software and one or more manual resources, a predefined chargeback model and a predefined billing policy.
